(19) United States
(12) Patent Application Publication
(10) Pub. No.: US 2022/0284264 A1
(43) Pub. Date: Sep. 8, 2022

(54) COMPUTER-READABLE RECORDING MEDIUM STORING PROGRAM, COMPUTER, AND LEARNING METHOD

(71) Applicant: FUJITSU LIMITED, Kawasaki-shi (JP)

(72) Inventor: Takumi Danjo, Kawasaki (JP)

(73) Assignee: FUJITSU LIMITED, Kawasaki-shi (JP)

(21) Appl. No.: 17/544,976

(22) Filed: Dec. 8, 2021

(30) Foreign Application Priority Data
Mar. 4, 2021 (JP) 2021-034728

(51) Int. Cl. G06N 3/04

(52) U.S. Cl. CPC G06N 3/04

(57) ABSTRACT

A non-transitory computer-readable recording medium storing a program for causing a computer to execute a procedure, the procedure includes in learning by a plurality of nodes in deep learning, determining to allocate a number of batches according to a performance of each of the plurality of nodes to the each of the plurality of nodes or to terminate the learning at a predetermined timing, and adjusting a learning rate to be used for the learning according to a ratio of a preset number of batches for the plurality of nodes to a number of execution batches executed by the allocation in the plurality of nodes or number of execution batches executed before the predetermined timing.

### CROSS-REFERENCE TO RELATED APPLICATION

This application is based upon and claims the benefit of priority of the prior Japanese Patent Application No. 2021-34728, filed on Mar. 4, 2021, the entire contents of which are incorporated herein by reference.

### FIELD

The embodiment relates to a program, a computer, and a learning method.

### BACKGROUND

A program that requires enormous computational complexity, such as high performance computing (HPC) and deep learning (DL), sometimes perform parallel calculations using nodes such as a plurality of processors and a plurality of computers because the computational complexity is insufficient with a single processor.

Japanese National Publication of International Patent Application No. 2018-518744 and US Patent Publication No. 2019/0258964 are disclosed as related art.

### SUMMARY

According to an aspect of the embodiments, a non-transitory computer-readable recording medium storing a program for causing a computer to execute a procedure, the procedure includes in learning by a plurality of nodes in deep learning, determining to allocate a number of batches according to a performance of each of the plurality of nodes to the each of the plurality of nodes or to terminate the learning at a predetermined timing, and adjusting a learning rate to be used for the learning according to a ratio of a preset number of batches for the plurality of nodes to a number of execution batches executed by the allocation in the plurality of nodes or number of execution batches executed before the predetermined timing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing Reduce processing in a related example;

FIG. 2 is a diagram for describing Allreduce processing in a related example;

FIG. 3 is a diagram for describing a first detailed example of the Reduce processing in the related example;

FIG. 4 is a diagram for describing a second detailed example of the Reduce processing in the related example;

FIG. 5 is a diagram for describing a third detailed example of the Reduce processing in the related example;

FIG. 6 is a diagram for describing a fourth detailed example of the Reduce processing in the related example;

FIG. 7 is a diagram for describing waiting for timing in the Allreduce processing in the related example;

FIG. 8 is a diagram for describing processing of optimizing the number of batches in one example of an embodiment;

FIG. 9 is a block diagram schematically illustrating a hardware configuration example of a computer in one example of an embodiment;

FIG. 10 is a block diagram schematically illustrating a software configuration example of the computer illustrated in FIG. 9;

FIG. 11 is a diagram for describing throughput measurement processing in the computer illustrated in FIG. 9;

FIG. 12 is a diagram for describing processing of setting the number of batches in the computer illustrated in FIG. 9;

FIG. 13 is a diagram for describing a main operation of batch processing in the computer illustrated in FIG. 9;

FIG. 14 is a flowchart for describing batch processing in one example of the embodiment;

FIG. 15 is a diagram for describing processing of optimizing the number of batches as a first modification;

FIG. 16 is a flowchart for describing the processing of optimizing the number of batches as the first modification;

FIG. 17 is a diagram for describing preconditions in processing of optimizing the number of batches as a second modification;

FIG. 18 is a diagram for describing the processing of optimizing the number of batches in a case where a specified process as the second modification has completed a target number of batches;

FIG. 19 is a diagram for describing the processing of optimizing the number of batches in a case where a specified time as the second modification has elapsed;

FIG. 20 is a diagram for describing the processing of optimizing the number of batches in a case where all of processes as the second modification have completed the target number of batches;

FIG. 21 is a flowchart for describing the processing of optimizing the number of batches as the second modification;

FIG. 22 is a diagram for describing processing of optimizing the number of batches as a third modification;

FIG. 23 is a flowchart for describing the processing of optimizing the number of batches as the third modification; and

FIG. 24 is a diagram for describing effects by the processing of optimizing the number of batches as one example of the embodiment and respective modifications.

### DESCRIPTION OF EMBODIMENTS

Even if a system including a plurality of nodes each configured by the same hardware and software is prepared, the processing speed between the nodes may differ by about several percent due to an influence of performance variation of processing chips, temperature conditions, and the like. As a result, in each node, in a case where, after respective first processing is executed, completion of the first processing in all the nodes is waited for and respective second processing is executed, processing performance may deteriorate due to occurrence of a waiting time.

### [A] Related Example

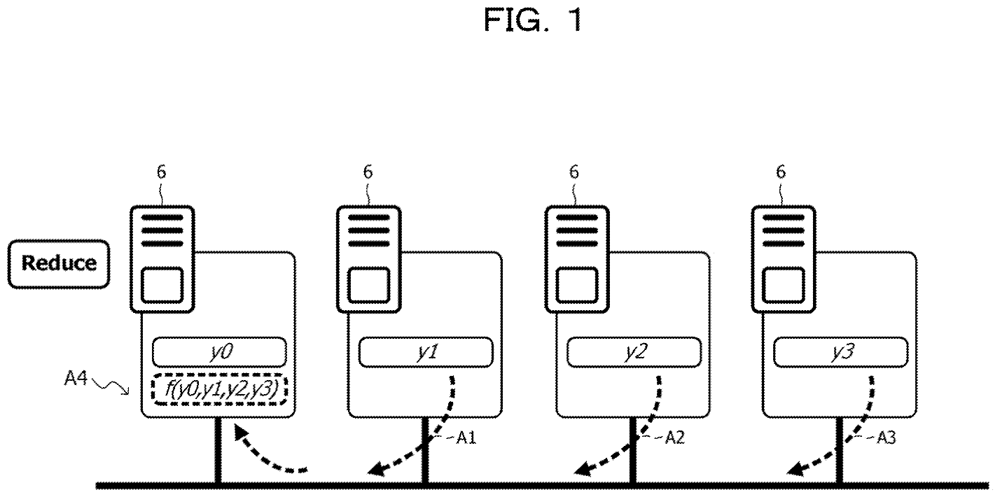

FIG. 1 is a diagram for describing Reduce processing in a related example.

Message passing interface (MPI) is a standardized standard for using parallel calculation. The Reduce processing is processing of combining values of a plurality of nodes 6 into one value using a certain function as illustrated in FIG. 1 in implementation of the MPI.

As illustrated in FIG. 1, it is assumed that four nodes 6 have values y0, y1, y2, and y3, respectively. When the Reduce processing is executed, the respective values are put together as illustrated with reference codes A1 to A3, and the function f (y0, y1, y2, y3) such as addition, multiplication, max, or min calculates one value, as illustrated with reference code A4.

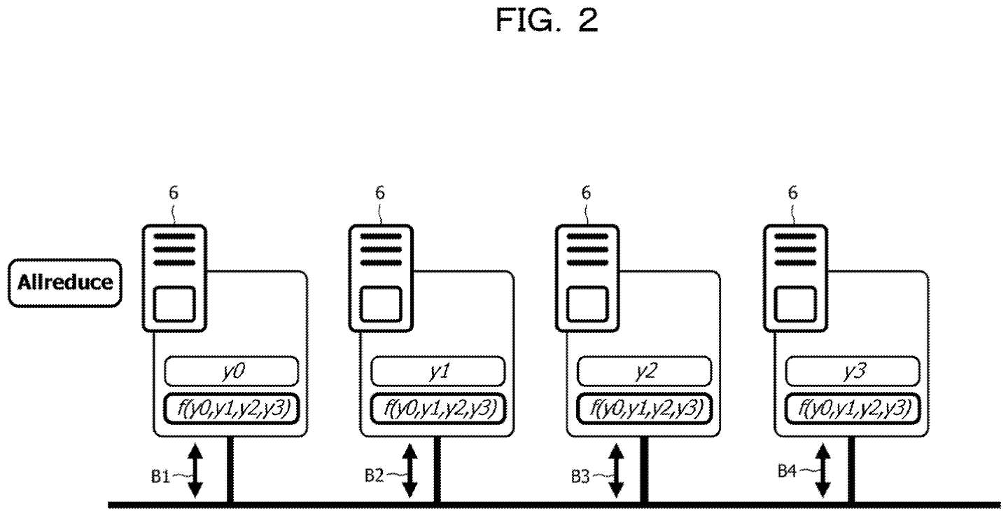

FIG. 2 is a diagram for describing Allreduce processing in the related example.

The Allreduce processing is processing in which a result of the Reduce processing is shared by all the nodes 6.

In the example illustrated in FIG. 2, the function f (y0, y1, y2, y3) is shared by all the nodes 6 as illustrated with reference codes B1 to B4.

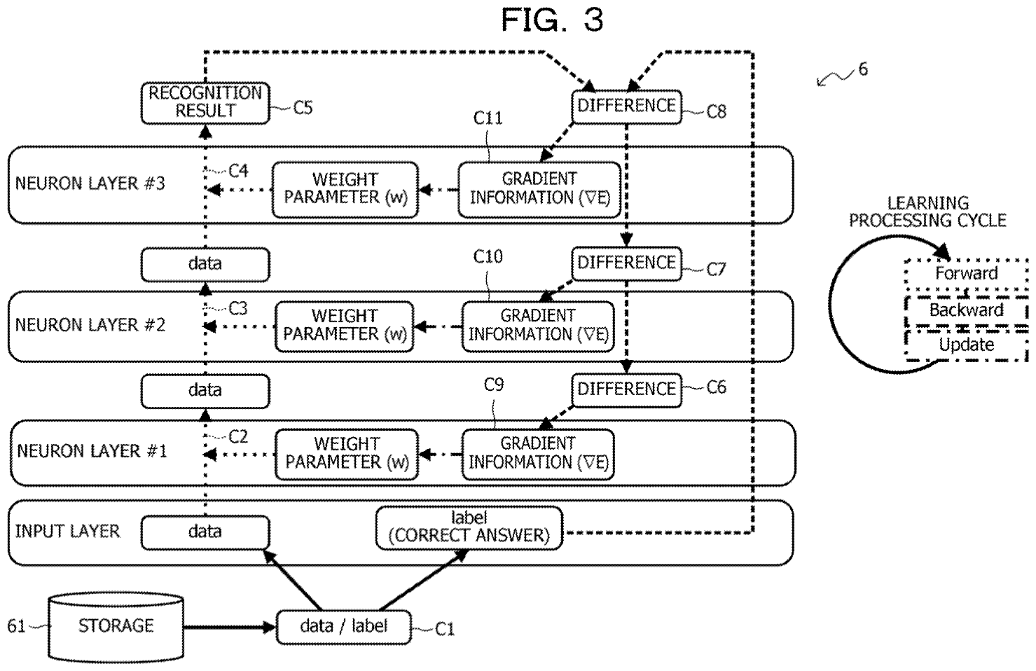

FIG. 3 is a diagram for describing a first detailed example of the Reduce processing in the related example.

In a case where DL is performed at the node 6, data and label (in other words, a correct answer) are input to an input layer from a storage 61 as illustrated with reference code C1.

In FIG. 3, the dotted arrows indicate Forward processing in a learning processing cycle, the dashed arrows indicate Backward processing in the learning processing cycle, and the alternate long and short dash arrows indicate Update processing in the learning processing cycle.

As illustrated with reference code C2, in a neuron layer #1, a weight parameter w is applied to the data from the input layer as the Forward processing. As illustrated with reference code C3, in a neuron layer #2, the weight parameter w is applied to the data from the neuron layer #1 as the Forward processing. As illustrated with reference code C4, in a neuron layer #3, the weight parameter w is applied to the data from the neuron layer #2 as the Forward processing.

Then, as illustrated with reference code C5, an output of the neuron layer #3 is acquired as a recognition result as the Forward processing.

As illustrated with reference codes C6 to C8, a difference between the label and the recognition result is input in each of the neuron layers #1 to #3 as the Backward processing.

As illustrated with reference codes C9 to C11, the difference input to each of the neuron layers #1 to #3 is applied to the weight parameter w as gradient information ∇E as the Update processing.

By repeating the above cycle many times, an appropriate weight parameter is acquired.

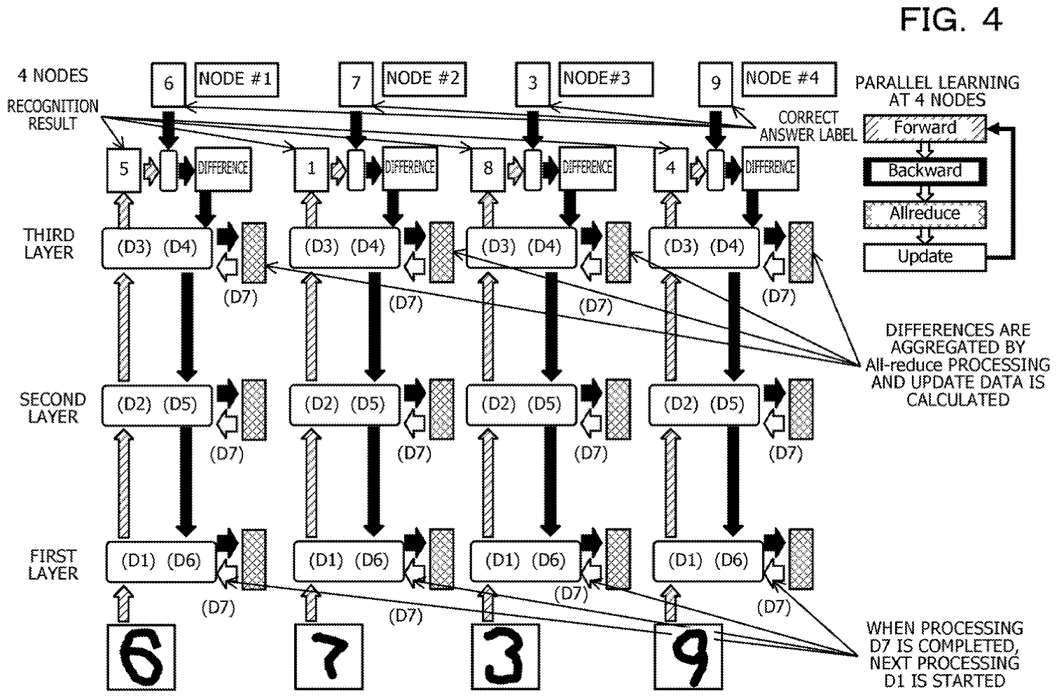

FIG. 4 is a diagram for describing a second detailed example of the Reduce processing in the related example.

In FIG. 4, single diagonally-lined arrows indicate the Forward processing, black arrows indicate the Backward processing, multiple diagonally-lined blocks indicate Allreduce processing, and white arrows indicate the Update processing.

When handwritten numbers “6”, “7”, “3”, and “9” are input at the nodes #1 to #4, respectively, the Forward processing is performed in each of the first to third layers as illustrated with reference codes D1 to D3.

In the example illustrated in FIG. 4, “5”, “1”, “8”, and “4” are respectively output from the third layers as recognition results in the nodes #1 to #4. Then, the difference between the recognition result and the correct answer label is calculated, and the Backward processing is performed in each of the third to first layers as illustrated with reference codes D4 to D6.

As illustrated with reference code D7, in each layer, the differences are aggregated and update data is calculated by the Allreduce processing, and the Update processing is performed.

When the processing illustrated with reference code D7 is completed, the processing illustrated with reference code D1 and the subsequent reference codes is started for the next input.

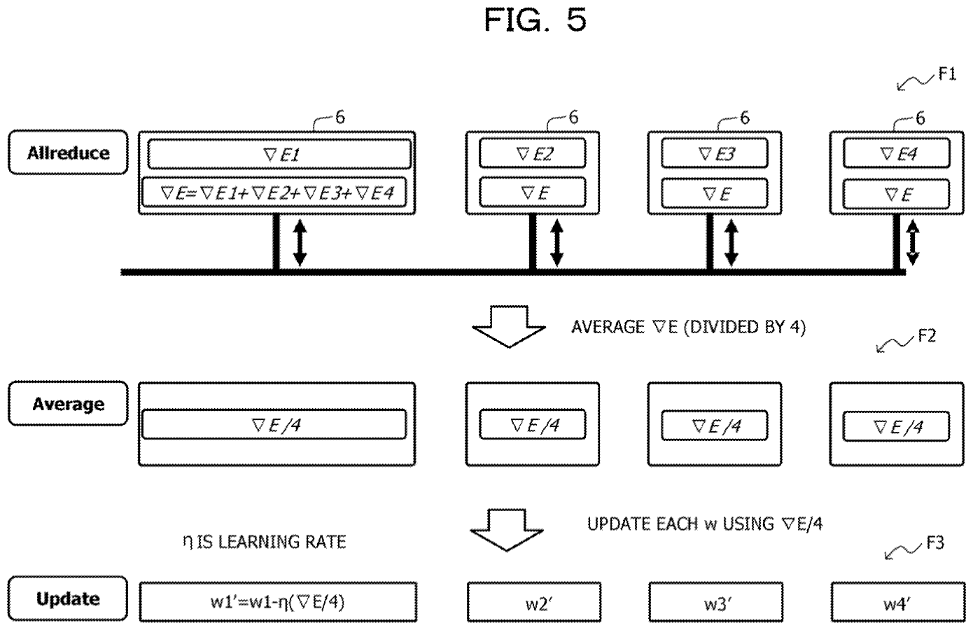

FIG. 5 is a diagram for describing a third detailed example of the Reduce processing in the related example.

In DL distributed processing, the gradient information of all the nodes 6 is added, and an added value is distributed to each node 6. Thereafter, the value is divided by the number of nodes, an average is calculated, and then the weight is updated at each node.

In the example illustrated in FIG. 5, as illustrated with reference code F1, ∇E=∇E1+∇E2+∇E3+∇E4 is calculated at each node by the Allreduce processing.

As illustrated with reference code F2, ∇E is averaged by dividing ∇E by 4 at each node by Average processing.

As illustrated with reference code F3, the weight parameter w is updated using ∇E/4 at each node by the Update processing.

For example, when a learning rate is η, the weight parameter after update with respect to the weight parameter w1 before update is calculated by w1′=w1−η(∇E/4).

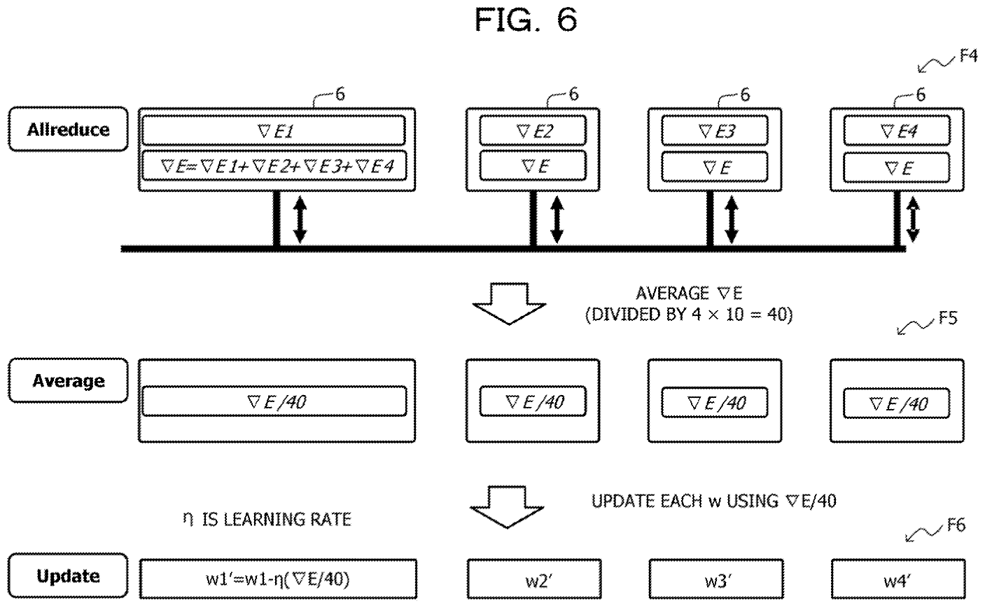

FIG. 6 is a diagram for describing a fourth detailed example of the Reduce processing in the related example.

In the DL distributed processing, a mini batch method may be used. In the mini batch method, each node 6 does not process one batch at a time, but processes a plurality of mini batches at a time.

In the example illustrated in FIG. 6, the number of mini batches at each node 6 is 10, and the number of global batches at the four nodes 6 is 40.

As illustrated with reference code F4, ∇E=∇E1+∇E2+∇E3+∇E4 is calculated at each node by the Allreduce processing.

As illustrated with reference code F5, ∇E is averaged by dividing ∇E by 4*10=40 at each node by the Average processing.

As illustrated with reference code F6, the weight parameter w is updated using ∇E/40 at each node by the Update processing.

For example, when the learning rate is η, the weight parameter after update with respect to the weight parameter w1 before update is calculated by w1′=w1−η(∇E/40).

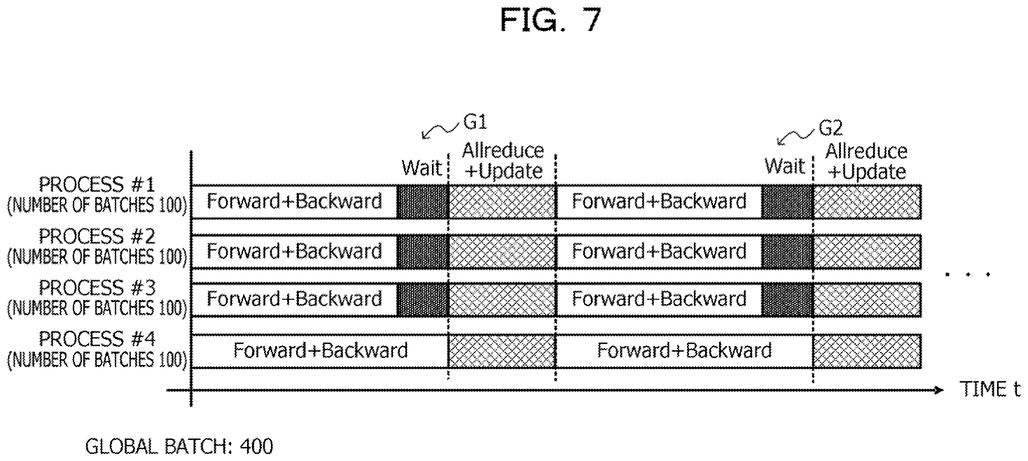

FIG. 7 is a diagram for describing waiting for timing in the Allreduce processing in the related example.

Even if a system including a plurality of nodes each configured by the same hardware and software is prepared, the processing speed between the nodes may differ by about several percent due to an influence of performance variation of processing chips, temperature conditions, and the like.

For example, the processing speed of a central processing unit (CPU) or graphic processing unit (GPU) may vary by automatically varying an operating clock depending on the temperature.

Since the Allreduce processing basically performs communication after completing one gradient calculation of all the processes, the processing performance is degraded by a waiting time.

In the example illustrated in FIG. 7, the number of batches of 100 is assigned to each of processes #1 to #4, and the global batch is 400. Note that, in consideration of processing by multi-CPU and multi-GPU using multi-process, hereinafter, the processing unit is defined as process.

As illustrated with reference codes G1 and G2, the time required for the Forward processing+Backward processing of the processes #1 to #3 is shorter than the time required for the Forward processing+Backward processing of the process #4. As a result, in the processes #1 to #3, a wait time occurs until start of the Allreduce processing+Update processing (in other words, until completion of the Forward processing+Backward processing in the process #4).

### [B] Embodiment

Hereinafter, an embodiment of a technology capable of reducing a waiting time until start of sharing of a processing result among nodes in a case of parallel calculation will be described with reference to the drawings. Note that the embodiments to be described below are merely examples, and there is no intention to exclude application of various modifications and technologies not explicitly described in the embodiments. For example, the present embodiment may be variously modified and implemented without departing from the scope of the gist thereof. Furthermore, each drawing is not intended to include only components illustrated in the drawings and may include another function and the like.

Hereinafter, each same reference code represents a similar part in the drawings, and thus description thereof will be omitted.

### [B-1] Configuration Example

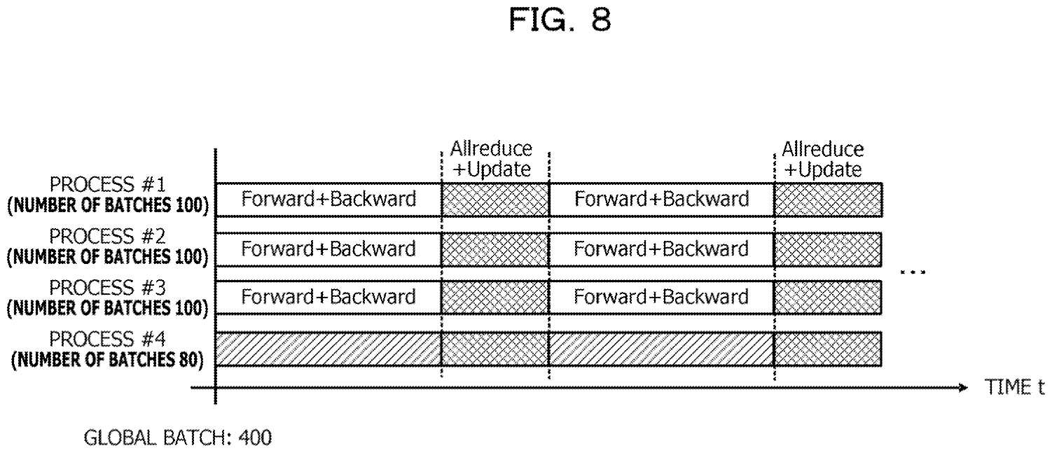

FIG. 8 is a diagram for describing processing of optimizing the number of batches in one example of an embodiment.

In one example of the embodiment, the wait time is reduced and the final learning time is shortened by changing the number of batches (in other words, “the number of mini batches” or “batch size”) according to the performance of each process. The total number of completed batches changes from the global batch depending on throughput and timing, but learning with comparable accuracy is possible by adjusting a learning rate in proportion to the change.

As illustrated in the following equation (1), if the number of samples is sufficiently larger than the number of mini batches, the learning rate is proportional to the number of batches when a noise scale is constant. That is, even if the actual total number of learning batches changes from the set number of global batches, learning with comparable accuracy becomes possible by adjusting the learning rate in proportion to the change.

$${η}^{′} = η * \frac{{batch}^{′}}{batch} \qquad ( 1 )$$

In the above equation (1), batch and batch′ respectively represent the numbers of batches before and after update, and η and η′ respectively represent the learning rates before and after the update.

In the example illustrated in FIG. 8, while the original number of global batches is 400, the number of batches of 100 is set for the processes #1 to #3, and the number of batches of 80 is distributed to the process #4, resulting in the number of batches in total as 380. As a result, in each process, no wait time occurs between the end of the Forward processing+Backward processing and the start of the Allreduce processing+Update processing.

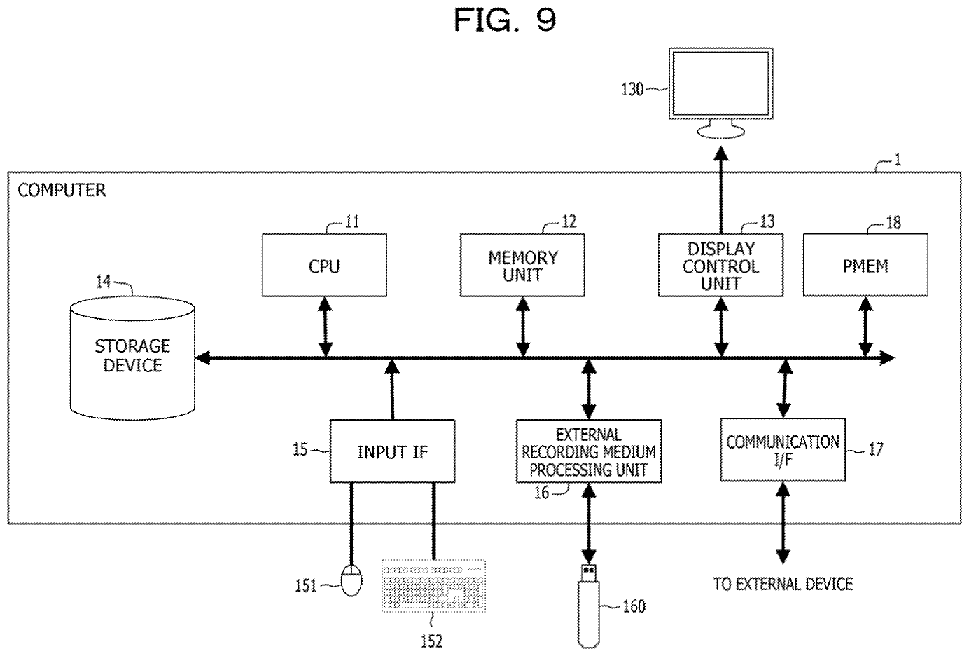

FIG. 9 is a block diagram schematically illustrating a hardware configuration example of a computer 1 in one example of the embodiment.

As illustrated in FIG. 9, the computer 1 has a server function, and includes a CPU 11, a memory unit 12, a display control unit 13, a storage device 14, an input interface (IF) 15, an external recording medium processing unit 16, and a communication IF 17. As illustrated in FIGS. 1 and 2, a plurality of the computers 1 may be provided as the nodes 6, and the parallel calculation may be executed in each of the computers 1. Furthermore, the computer 1 may include a plurality of the CPUs 11, and the parallel calculation may be executed in each of the CPUs 11.

The memory unit 12 is one example of a storage unit, which is, for example, a read only memory (ROM), a random access memory (RAM), and the like. Programs such as a basic input/output system (BIOS) may be written into the ROM of the memory unit 12. A software program of the memory unit 12 may be appropriately read and executed by the CPU 11. Furthermore, the RAM of the memory unit 12 may be used as a temporary recording memory or a working memory.

The display control unit 13 is connected to a display device 130 and controls the display device 130. The display device 130 is a liquid crystal display, an organic light-emitting diode (OLED) display, a cathode ray tube (CRT), an electronic paper display, or the like, and displays various kinds of information for an operator or the like. The display device 130 may be combined with an input device and may be, for example, a touch panel.

The storage device 14 is a storage device having high input/output (IO) performance, and for example, a dynamic random access memory (DRAM), a solid state drive (SSD), a storage class memory (SCM), or a hard disk drive (HDD) may be used.

The input IF 15 may be connected to an input device such as a mouse 151 and a keyboard 152, and may control the input device such as the mouse 151 and the keyboard 152. The mouse 151 and the keyboard 152 are examples of the input devices, and an operator performs various kinds of input operation through these input devices.

The external recording medium processing unit 16 is configured to have a recording medium 160 attachable thereto. The external recording medium processing unit 16 is configured to be capable of reading information recorded in the recording medium 160 in a state where the recording medium 160 is attached thereto. In the present example, the recording medium 160 is portable. For example, the recording medium 160 is a flexible disk, an optical disk, a magnetic disk, a magneto-optical disk, a semiconductor memory, or the like.

The communication IF 17 is an interface for enabling communication with an external device.

The CPU 11 is one example of a processor, and is a processing device that performs various controls and calculations. The CPU 11 implements various functions by executing an operating system (OS) or a program loaded in the memory unit 12.

A device for controlling the operation of the entire computer 1 is not limited to the CPU 11 and may be, for example, any one of an MPU, a DSP, an ASIC, a PLD, and an FPGA. Furthermore, the device for controlling the operation of the entire computer 1 may be a combination of two or more of the CPU, the MPU, the DSP, the ASIC, the PLD, and the FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

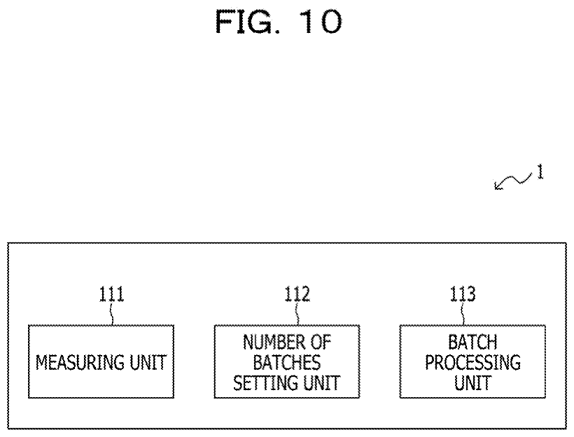

FIG. 10 is a block diagram schematically illustrating a software configuration example of the computer 1 illustrated in FIG. 9.

The computer 1 functions as a measuring unit 111, a number of batches setting unit 112, and a batch processing unit 113.

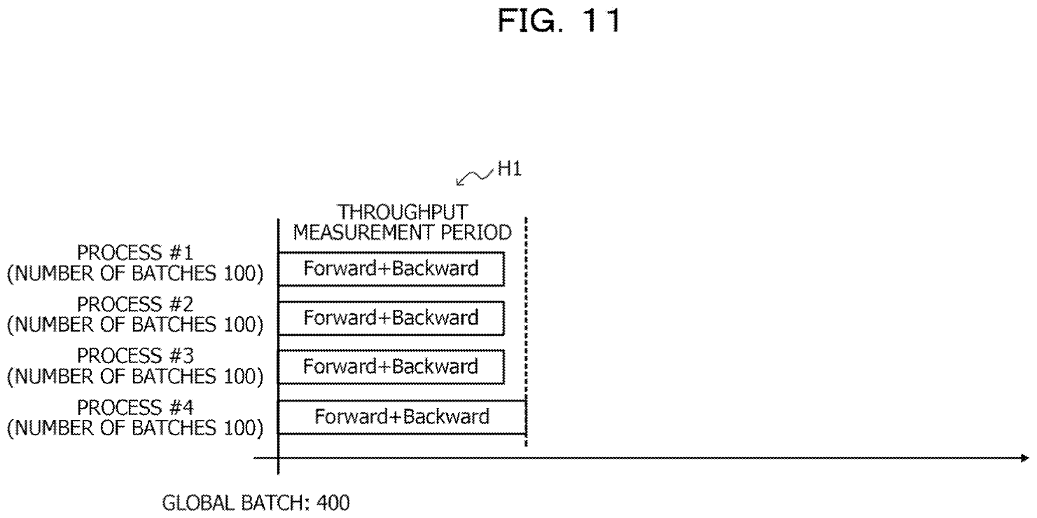

The measuring unit 111 measures the performance of each single node (in other words, the throughput). Details of processing by the measuring unit 111 will be described below with reference to FIG. 11 and the like.

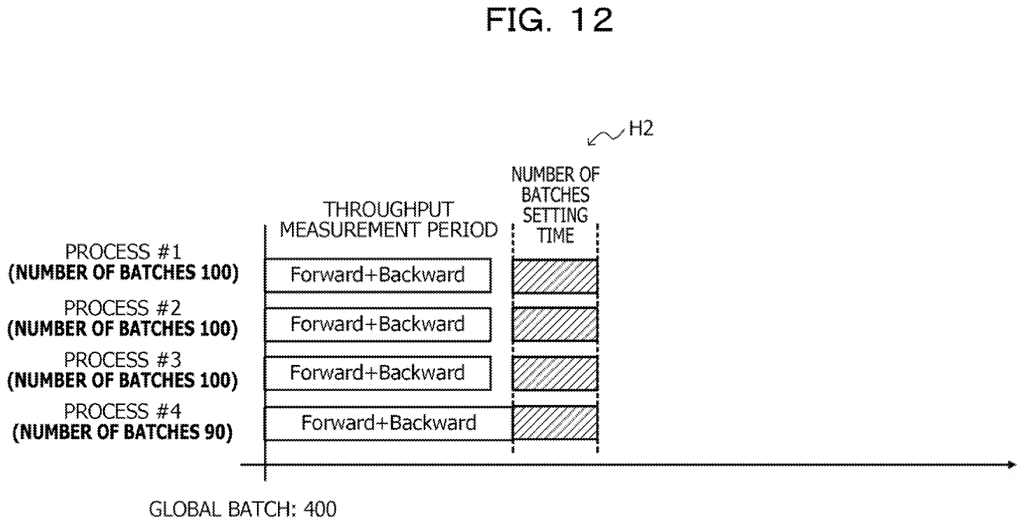

The number of batches setting unit 112 distributes the number of batches to each node according to the performance of each node. Details of processing by the number of batches setting unit 112 will be described below with reference to FIG. 12 and the like.

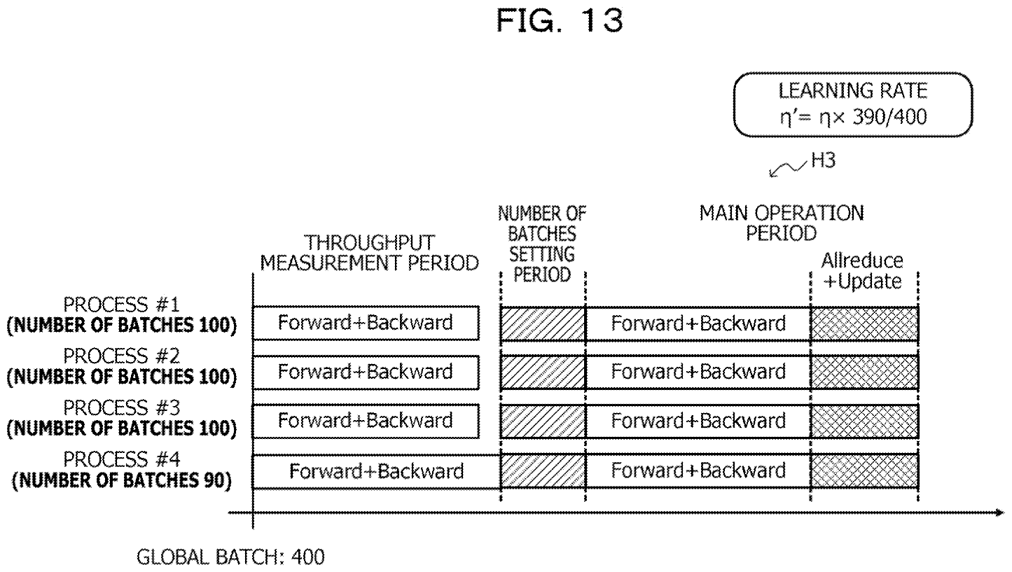

The batch processing unit 113 processes the batches set in each node. Details of the processing by the batch processing unit 113 will be described below with reference to FIG. 13 and the like.

FIG. 11 is a diagram for describing throughput measurement processing in the computer 1 illustrated in FIG. 9.

The measuring unit 111 measures the individual performance of each process. For example, the number of sheets that can be processed in a certain period T (which may be an appropriate time, the number of iterations, or the number of epochs) may be calculated as the throughput by running learning to be performed.

In measurement processing, communication between nodes and update of weight parameters are not required. Furthermore, the number of batches may be large to some extent in order to obtain a maximum speed.

In the example illustrated in FIG. 11, the number of batches is set to 100 in each of processes #1 to #4. However, as illustrated with reference code H1, the processing time of the Forward processing+Backward processing in the processes #1 to #3 is calculated to be shorter than the processing time of the Forward processing+Backward processing in the process #4 during a throughput measurement period.

FIG. 12 is a diagram for describing processing of setting the number of batches in the computer 1 illustrated in FIG. 9.

Next, the number of batches setting unit 112 assigns mini batches for each process according to a throughput ratio of each process, with the number of global batches as a set value. For example, in a case where the number of global batches is 400 and the throughput ratio is 10:10:10:9 for four processes, the numbers of mini batches for the processes are 100:100:100:90, and the number of batches in total is 390.

In the example illustrated in FIG. 12, the number of batches is assigned during a number of batches setting period illustrated with reference code H2. Furthermore, the learning rate is changed from the original learning rate η to the new learning rate η′=η*390/400.

That is, in the learning by a plurality of nodes in deep learning, the number of batches setting unit 112 allocates the number of batches according to the performance of each of the plurality of nodes to each of the plurality of nodes. Furthermore, the number of batches setting unit 112 adjusts the learning rate to be used for learning according to a ratio of the preset number of batches for a plurality of nodes to the number of execution batches executed by allocation in the plurality of nodes.

FIG. 13 is a diagram for describing a main operation of batch processing in the computer 1 illustrated in FIG. 9.

The batch processing unit 113 runs each process according to the number of batches and the new learning rate η′ set by the number of batches setting unit 112, and starts parallel learning. As a result, a waiting period for the Allreduce processing disappears during the main operation period and learning can be efficiently performed. Note that the number of sheets learned in 1 epoch does not change.

In the example illustrated in FIG. 13, as illustrated with reference code H3, in the processes #1 to #4, the Allreduce processing+Update processing can be executed without wait time after the Forward processing+Backward processing in the main operation period.

### [B-2] Operation Example

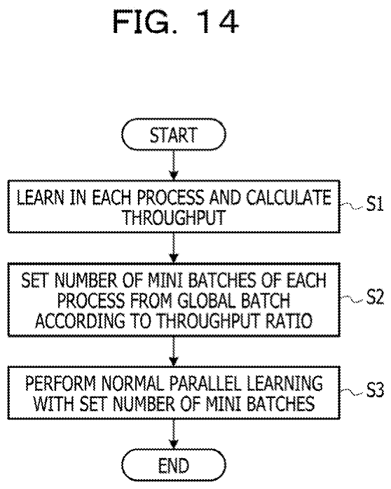

The batch processing in one example of the embodiment will be described with reference to the flowchart (operations S1 to S3) illustrated in FIG. 14.

The measuring unit 111 learns in each process and calculates the throughput (operation S1).

The number of batches setting unit 112 sets the number of mini batches of each process from the number of global batches according to the throughput ratio (operation S2).

The batch processing unit 113 executes normal parallel learning in each process with the set number of mini batches (operation S3). Then, the batch processing ends.

### [C] First Modification

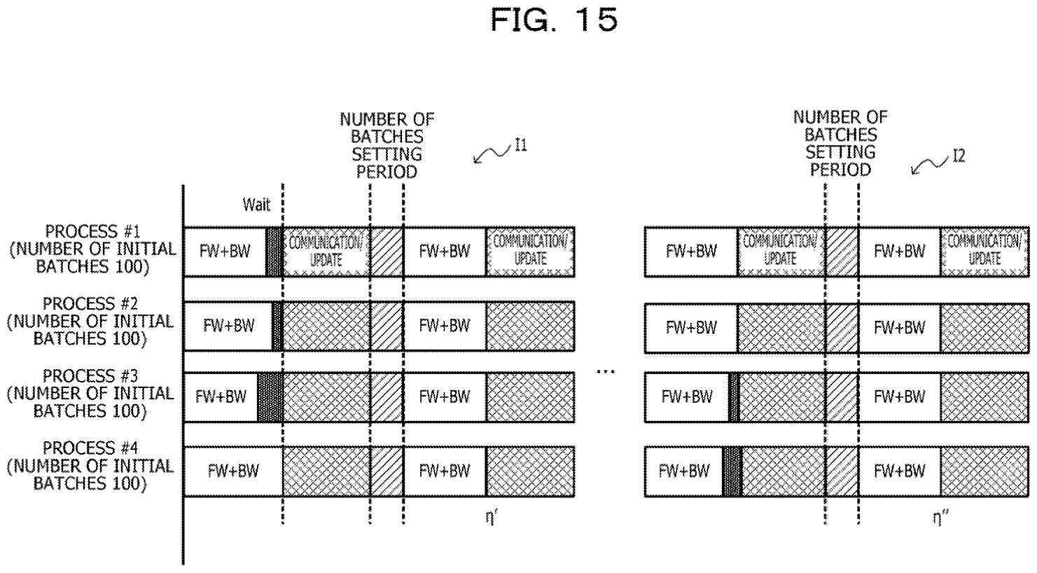

FIG. 15 is a diagram for describing processing of optimizing the number of batches as a first modification.

The throughput in each process may change over time depending on the temperature of the CPU 11, a use status of the computer 1, and the like.

In the example illustrated in FIG. 15, as illustrated with reference code I1, the wait time has occurred between the completion of the Forward processing+Backward processing and the start of communication processing/update processing in the processes #1 to #3. Therefore, the processing time has been smoothed by setting the number of batches and the learning rate η′. However, as illustrated by reference code 12, the wait time has occurred between the completion of the Forward processing+Backward processing and the start of communication processing/update processing in the processes #3 and #4, with the passage of time.

Therefore, in the first modification, the actual throughput of each process may be measured every time or every plurality of times of learning iterations, or every predetermined time, and the number of batches allocated to each processor may be changed and the learning rate η′ may be changed to the learning rate η″.

That is, the number of batches setting unit 112 may measure the performance and allocate the number of batches every predetermined number of iterations of learning. The number of batches setting unit 112 may measure the performance and allocate the number of batches every predetermined time.

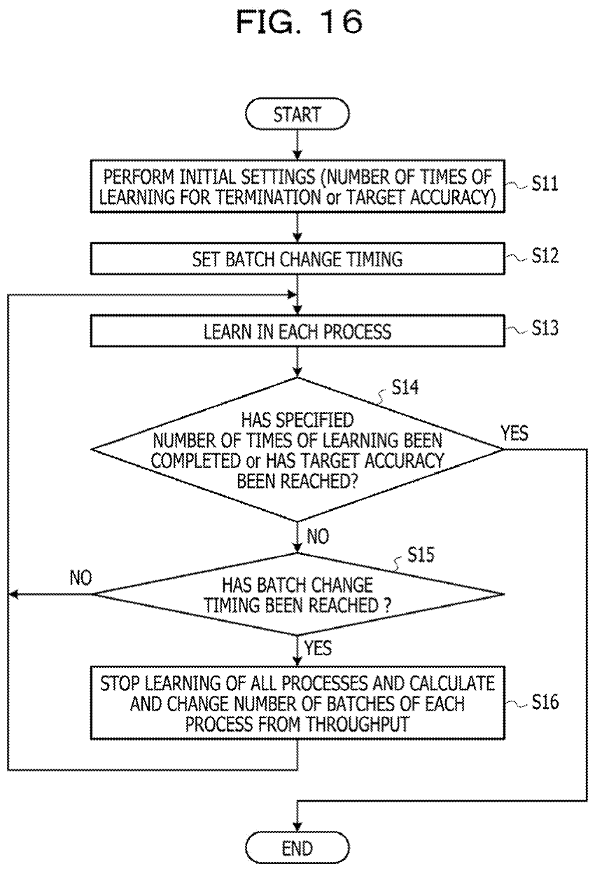

The processing of optimizing the number of batches as the first modification will be described with reference to the flowchart (operations S11 to S16) illustrated in FIG. 16.

The batch processing unit 113 performs initial settings such as the number of times of learning processing or target accuracy (operation S11).

The number of batches setting unit 112 sets batch change timing (operation S12). The batch change timing may be every number of iterations of learning such as every 100 times, every learning time such as every 30 minutes, or timing when the wait time has exceeded a threshold value.

The batch processing unit 113 executes learning in each process (operation S13).

The batch processing unit 113 determines whether a specified number of times of learning has been completed or the target accuracy has been reached (operation S14).

In the case where the specified number of times of learning has been completed or the target accuracy has been reached (see YES route in operation S14), the processing of optimizing the number of batches as the first modification is completed.

On the other hand, in the case where the specified number of times of learning has not been completed or the target accuracy has not been reached (see NO route in operation S14), the number of batches setting unit 112 determines whether the batch change timing has been reached (operation S15).

In the case where the batch change timing has not been reached (see NO route in operation S15), the processing returns to operation S13.

On the other hand, in the case where the batch change timing has been reached (see the YES route in operation S15), the number of batches setting unit 112 stops the learning of all the processes, calculates the number of batches and the new learning rate of each process from the throughput, and changes the number of batches and the new learning rate (operation S16). Then, the processing returns to operation S13.

### [D] Second Modification

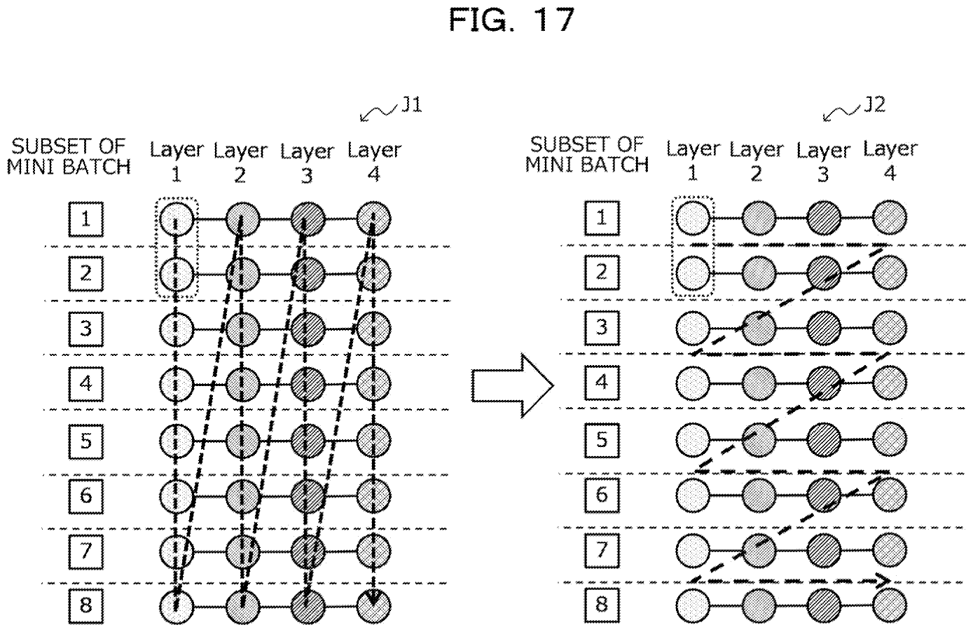

FIG. 17 is a diagram for describing preconditions in processing of optimizing the number of batches as a second modification.

Usually, in the mini batch method, a procedure of calculating only the number of batches in order from the previous layer and then moving to the next layer is performed. In the example illustrated with reference code J1, two subsets of mini batches of Layer1 are processed in order from “1” to “8”, then two subsets of mini batches of Layer1 are processed in order from “1” to “8”, two subsets of mini batches of Layer3 are processed in order from 1 to 8, and finally two subsets of mini batches of Layer4 are processed in order from 1 to 8.

Meanwhile, in the processing of optimizing the number of batches in the second modification, two subsets of mini batches are processed in all the layers, and then next two subsets of mini batches are processed in all the layers. In the example illustrated with reference code J2, “1” and “2” in the subsets of mini batches are processed from Layer1 to Layer4, then “3” and “4” in the subsets of mini batches are processed from Layer1 to Layer4, “5” and “6” in the subsets of mini batches are processed from Layer1 to Layer4, and finally “7” and “8” of the subsets of mini batches are processed from Layer1 to Layer4.

In the second modification, the batch processing unit 113 forcibly executes the Allreduce processing at specific timing. The specific timing may be, for example, timing when a specified process has completed the target number of batches, timing when a specified time has elapsed, or timing when all the processes has completed the target number of batches.

For processes with high processing speed, the process is continued to learn without stopping even after the processing of the specified number of batches is completed, the wait time of each process can be reduced and the learning can be speeded up.

That is, the number of batches setting unit 112 determines to terminate the learning at predetermined timing in the learning by a plurality of nodes in deep learning. Furthermore, the number of batches setting unit 112 adjusts the learning rate to be used for learning according to a ratio of the preset number of batches for a plurality of nodes to the number of execution batches executed before predetermined timing.

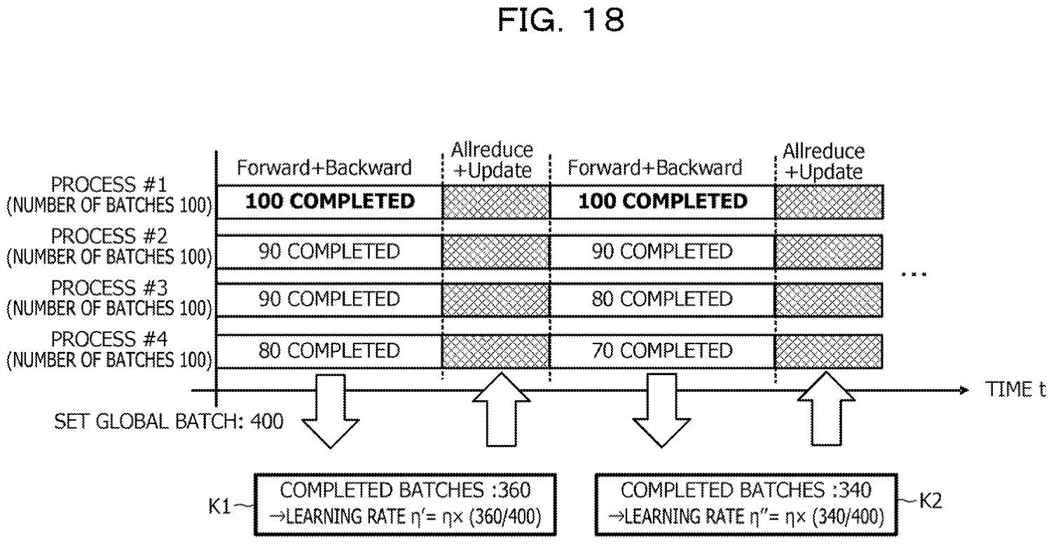

FIG. 18 is a diagram for describing the processing of optimizing the number of batches in a case where a specified process as the second modification has completed a target number of batches.

In the example illustrated in FIG. 18, each of the numbers of batches of the processes #1 to #4 is 100, a set global batch is 400, the process #1 is specified, and the target number of batches is set to 100.

As illustrated with reference code K1, even if processing in the other processes #2 to #4 has not been completed at timing when the target number of batches of 100 has been reached in the specified process #1, the forced Allreduce processing is executed. In this forced Allreduce processing, the process #1 has completed the processing of the number of batches of 100, the processes #2 and #3 each have completed the processing of the number of batches of 90, and the process #4 has completed the processing of the number of batches of 80. Therefore, the total number of completed batches is 360.

The learning rate η after update is calculated by the following equation (1) described above, and the Update processing is executed. Note that batch represents the set global batch, and batch′ represents the total number of completed batches.

$${η}^{′} = η * \frac{{batch}^{′}}{batch} \qquad ( 1 )$$

In the forced Allreduce processing illustrated with reference code K1, the learning rate after update η′=η×(360/400) is calculated.

Furthermore, as illustrated with reference code K2, even if processing in the other processes #2 to #4 has not been completed at timing when the target number of batches of 100 has been reached in the specified process #1, the Allreduce processing is executed. At this timing, the process #1 has completed the processing of the number of batches of 100, the process #2 has completed the processing of the number of batches of 90, the process #3 has completed the processing of the number of batches of 80, and the process #4 has completed the processing of the number of batches of 70. Therefore, the total number of completed batches is 340. In the forced Allreduce processing illustrated with reference code K2, the learning rate after update η″=η×(340/400) is calculated.

When the number of specified processes is 2 or more, the completed processes may be stopped or may be kept learning to increase the number of learnings from the target number of batches.

That is, the predetermined timing to terminate the learning may be timing when the number of batches executed by the first node of the plurality of nodes has reached a predetermined number since the start of learning.

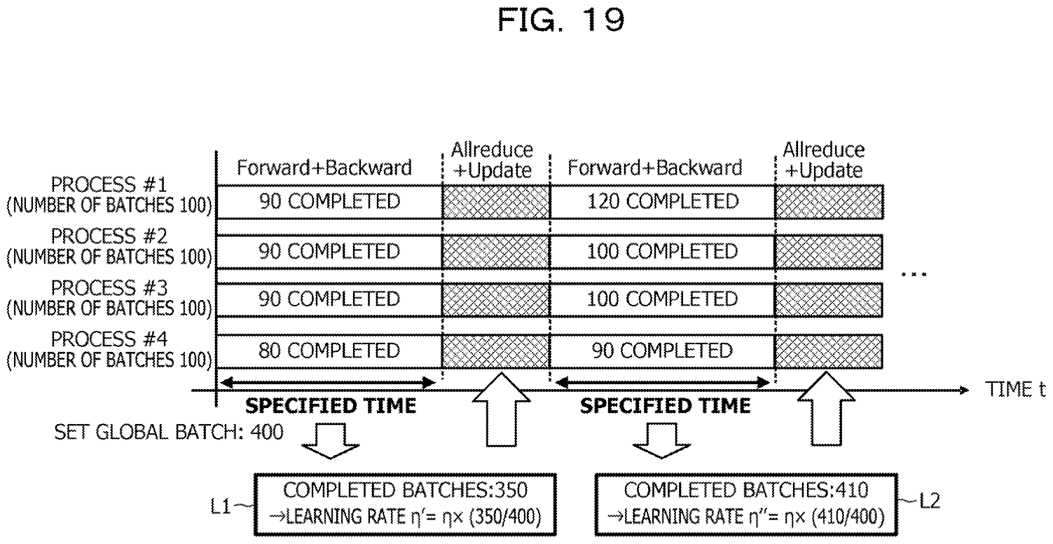

FIG. 19 is a diagram for describing the processing of optimizing the number of batches in a case where a specified time as the second modification has elapsed.

In the example illustrated in FIG. 19, each of the numbers of batches of the processes #1 to #4 is 100, the set global batch is 400, and an arbitrary specified time in which the forced Allreduce processing is executed is set.

As illustrated with reference code L1, even if the target number of batches of 100 has not been reached in all the processes #1 to #4, the forced Allreduce processing is executed at timing when the specified time has elapsed. In this forced Allreduce processing, the processes #1 to #3 each have completed the processing of the number of batches of 90, and the process #4 has completed the processing of the number of batches of 80. Therefore, the total number of completed batches is 350. Furthermore, the learning rate after update is calculated as η′=η×(350/400) as in the case illustrated in FIG. 18.

As illustrated with reference code L2, the forced Allreduce processing is executed at timing when the second specified time has elapsed. In this forced Allreduce processing, the process #1 has completed the processing of the number of batches of 120 that is larger than the target number of batches of 100, the processes #2 and #3 have completed the processing of the number of batches of 100 that is the same as the target number of batches of 100, and the process #4 has completed the processing of the number of batches of 90. Therefore, the total number of completed batches is 410. Furthermore, the learning rate after update is calculated as η″=η×(410/400) as in the case illustrated in FIG. 18.

Note that, in the forced Allreduce processing illustrated with reference code L2, the processing of the process #1 may be stopped at timing when the target number of batches has been reached to generate a wait time.

That is, the predetermined timing to terminate the learning may be timing when a predetermined time has elapsed since the start of learning.

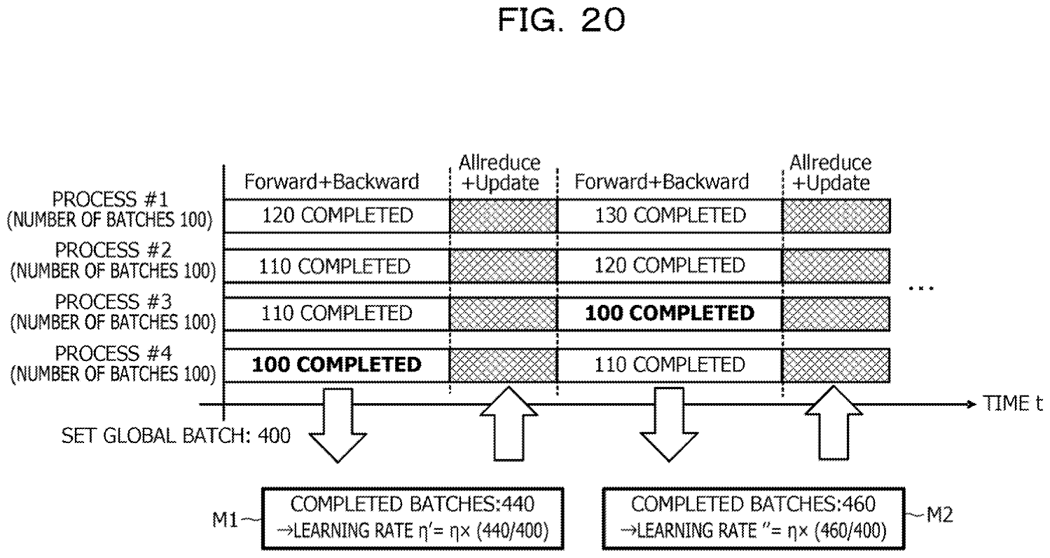

FIG. 20 is a diagram for describing the processing of optimizing the number of batches in a case where all of processes as the second modification have completed the target number of batches.

In the example illustrated in FIG. 20, each of the numbers of batches of the processes #1 to #4 is 100, and the set global batch is 400.

As illustrated with reference code M1, the forced Allreduce processing is executed at timing when the target number of batches of 100 has been reached in all the processes #1 to #4 and a processing completion flag in all the processes has been output. In this forced Allreduce processing, the process #1 has completed the processing of the number of batches of 120, the processes #2 and #3 have completed the processing of the number of batches of 110, and the process #4 has completed the processing of the number of batches of 100. Therefore, the total number of completed batches is 440. Furthermore, the learning rate after update is calculated as η′=η×(440/400) as in the case illustrated in FIG. 18.

As illustrated with reference code M2, the forced Allreduce processing is executed at timing when the target number of batches of 100 is reached in all the processes #1 to #4 and a processing completion flag in all the processes is output. In this forced Allreduce processing, the process #1 has completed the processing of the number of batches of 130, the process #2 has completed the processing of the number of batches of 120, the process #3 has completed the processing of the number of batches of 100, and the process #4 has completed the processing of the number of batches of 110. Therefore, the total number of completed batches is 460. Furthermore, the learning rate after update is calculated as η″=η×(460/400) as in the case illustrated in FIG. 18.

That is, the predetermined timing to terminate the learning may be timing when the number of batches executed by all the plurality of nodes has reached a predetermined number since the start of learning.

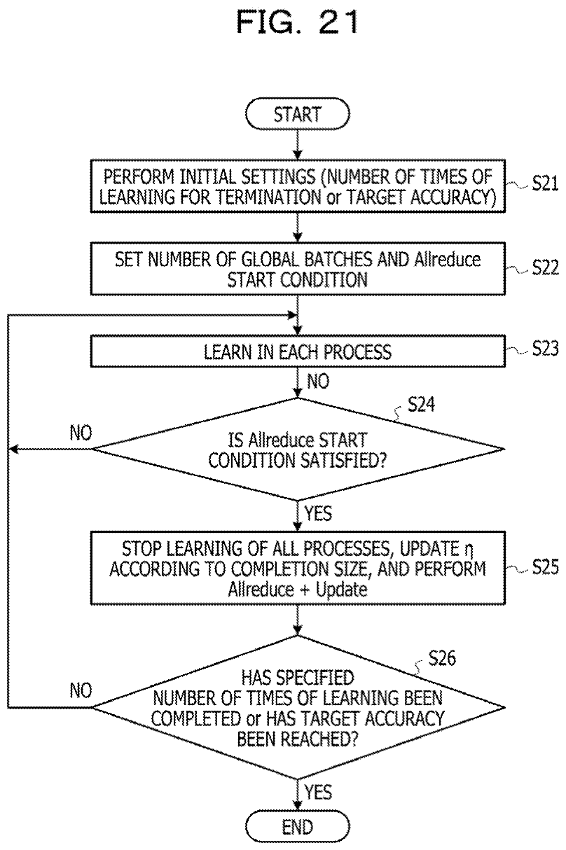

The processing of optimizing the number of batches as a second modification will be described with reference to the flowchart (operations S21 to S26) illustrated in FIG. 21.

The batch processing unit 113 performs initial settings such as the number of times of learning processing or target accuracy (operation S21).

The number of batches setting unit 112 sets the number of global batches and a start condition of the Allreduce processing (operation S22). The timing serving as the start condition of the Allreduce processing may be, for example, timing when a specified process has completed the target number of batches, timing when a specified time has elapsed, or timing when all the processes has completed the target number of batches.

The batch processing unit 113 executes learning in each process (operation S23).

The batch processing unit 113 determines whether the start condition of the Allreduce processing is satisfied (operation S24).

In the case where the start condition of the Allreduce processing is not satisfied (see NO route in operation S24), the processing returns to operation S23.

On the other hand, in the case where the start condition of the Allreduce processing is satisfied (see YES route in operation S24), the number of batches setting unit 112 stops the learning of all the processes, updates the learning rate η according to a completion size, and executes the Allreduce processing and Update processing (operation S25).

The number of batches setting unit 112 determines whether a specified number of times of learning has been completed or the target accuracy has been reached (operation S26).

In the case where the specified number of times of learning has not been completed or the target accuracy has not been reached (see NO route in operation S26), the processing returns to operation S23.

On the other hand, in the case where the specified number of times of learning has been completed or the target accuracy has been reached (see YES route in operation S26), the processing of optimizing the number of batches as the second modification is completed.

### [E] Third Modification

In the second modification, the order-changing neural network processing has been performed to vary the learning rate on a steady basis, but in reality, the execution speed may not change in such a short period of time. Therefore, in the present third modification, learning is performed using the order-changing neural network processing once every predetermined number of iterations or once every predetermined period, and then the processing may be executed using normal order neural network processing. That is, the order-changing neural network processing may be used only when determining optimization of the number of batches, and the normal order neural network processing may be used for the predetermined number of iterations or the predetermined period in which the number of batches and the learning rate are fixed.

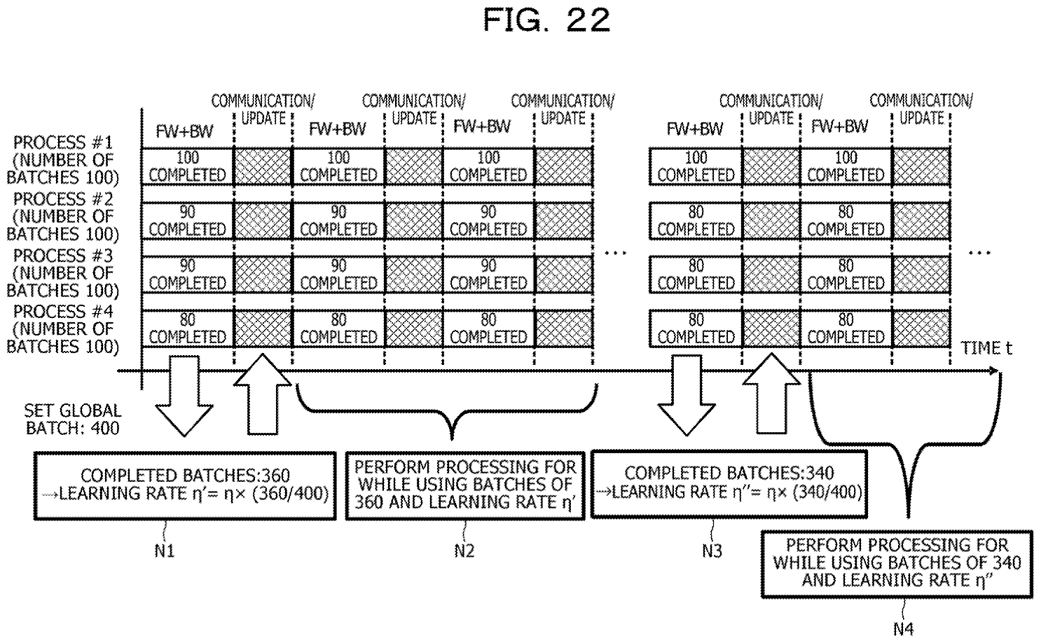

FIG. 22 is a diagram for describing processing of optimizing the number of batches as the third modification.

In the example illustrated in FIG. 22, each of the numbers of batches of the processes #1 to #4 is 100, and the set global batch is 400.

As illustrated with reference code N1, the processing of optimizing the number of batches is executed, the process #1 has completed the processing of the number of batches of 100, the processes #2 and #3 each have completed the processing of the number of batches of 90, and the process #4 has completed the processing of the number of batches of 80. Therefore, the total number of completed batches is 360. Furthermore, the learning rate after update is calculated as η′=η×(360/400) as in the case illustrated in FIG. 18.

As illustrated with reference code N2, the processing is repeated for a while using the total number of batches of 360 and the learning rate η′ calculated in reference code N1.

Then, the processing of optimizing the number of batches is executed again when the processing of the predetermined number of iterations has been repeated, or the predetermined period has elapsed. As illustrated with reference code N3, the process #1 has completed the processing of the number of batches of 100, and the processes #2 to #4 each have completed the processing of the number of batches of 80. Therefore, the total number of completed batches is 340. Furthermore, the learning rate after update is calculated as η″=η× (340/400) as in the case illustrated in FIG. 18.

As illustrated with reference code N4, the processing is repeated for a while using the total number of batches of 340 and the learning rate η″ calculated in reference code N3.

That is, the number of batches setting unit 112 may terminate the learning every predetermined number of iterations of learning. The number of batches setting unit 112 may terminate the learning every predetermined time.

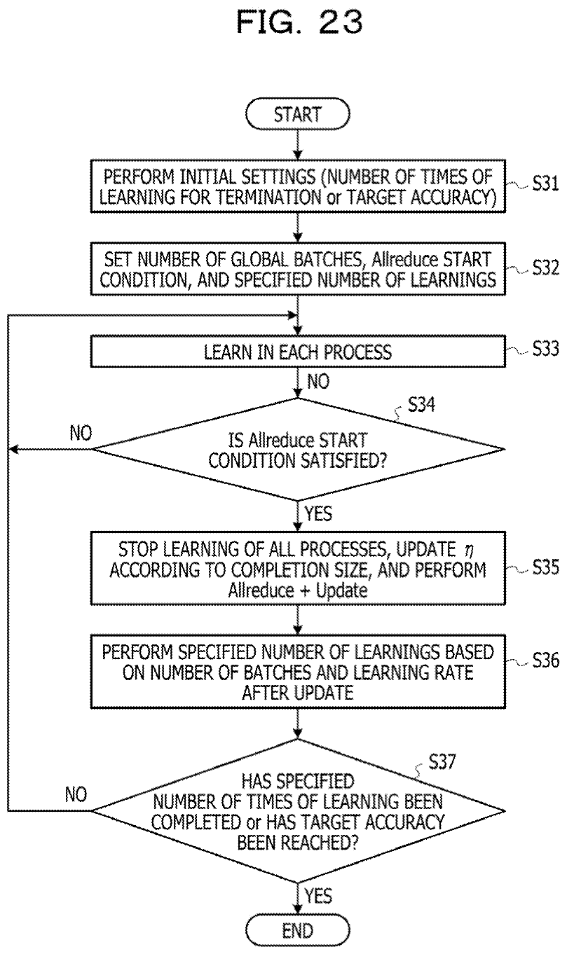

The processing of optimizing the number of batches as a third modification will be described with reference to the flowchart (operations S31 to S37) illustrated in FIG. 23.

The batch processing unit 113 performs initial settings such as the number of times of learning processing or target accuracy (operation S31).

The number of batches setting unit 112 sets the number of global batches and a start condition and a specified number of learnings of the Allreduce processing (operation S32). The specified number of learnings is the number of times learning is performed using values of the number of batches and the learning rate after updating these values, and may be determined according to a predetermined number of iterations or a predetermined period.

The batch processing unit 113 executes learning in each process (operation S33).

The batch processing unit 113 determines whether the start condition of the Allreduce processing is satisfied (operation S34).

In the case where the start condition of the Allreduce processing is not satisfied (see NO route in operation S34), the processing returns to operation S33.

On the other hand, in the case where the start condition of the Allreduce processing is satisfied (see YES route in operation S34), the number of batches setting unit 112 stops the learning of all the processes, updates the learning rate η according to a completion size, and executes the Allreduce processing and Update processing (operation S35).

The batch processing unit 113 performs the specified number of learnings based on the number of batches and the learning rate after update (operation S36).

The number of batches setting unit 112 determines whether a specified number of times of learning has been completed or the target accuracy has been reached (operation S37).

In the case where the specified number of times of learning has not been completed or the target accuracy has not been reached (see NO route in operation S37), the processing returns to operation S33.

On the other hand, in the case where the specified number of times of learning has been completed or the target accuracy has been reached (see YES route in operation S37), the processing of optimizing the number of batches as the third modification is completed.

### [F] Effects

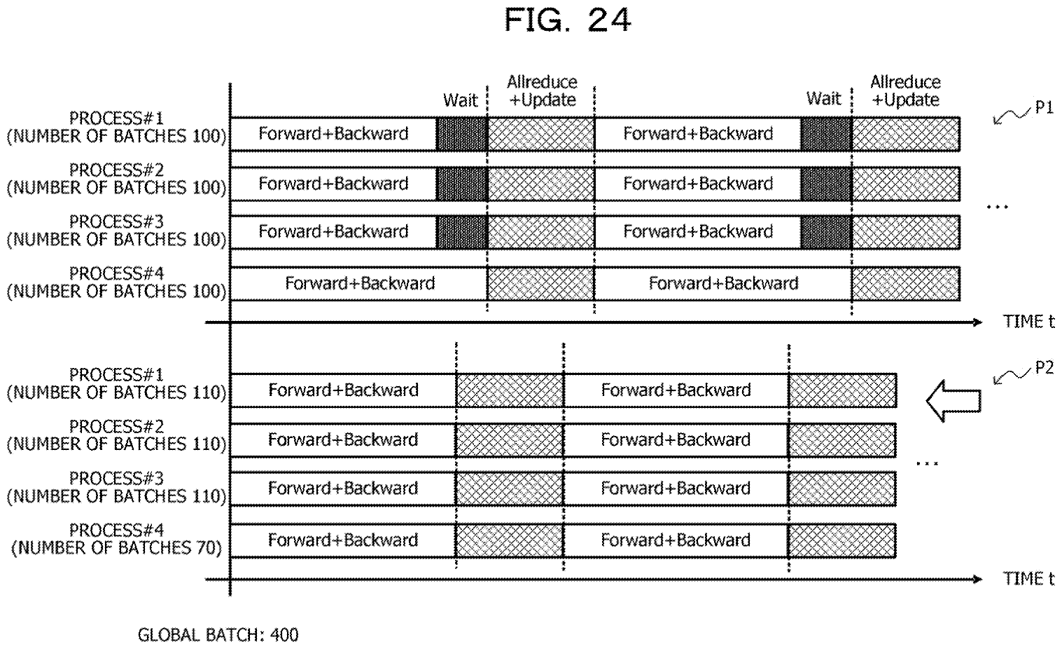

FIG. 24 is a diagram for describing effects by the processing of optimizing the number of batches as one example of the embodiment and the respective modifications.

When performing learning using a plurality of processes, by assigning the precondition for the Allreduce processing and setting the learning rate according to the precondition, the waiting time for communication can be reduced, and as a result, the entire learning time can be reduced without degrading the accuracy.

In the example illustrated in FIG. 24, as illustrated with reference code P1, the number of batches of 100 is allocated to each process, and the processes #1 to #3 have the wait time but the process #4 does not have the wait time. Therefore, as illustrated with reference code P2, for example, by reducing the number of batches of the processes #2 to #4 and updating the learning rate, the processing time of the entire processes can be reduced.

According to the program, the computer 1, and the learning method in one example of the embodiment and the respective modifications described above, the following effects can be exerted, for example.

That is, in the learning by a plurality of nodes in deep learning, the number of batches setting unit 112 determines to allocate the number of batches according to the performance of each of the plurality of nodes to each of the plurality of nodes, or to terminate the learning at predetermined timing. Furthermore, the number of batches setting unit 112 adjusts the learning rate to be used for learning according to a ratio of the preset number of batches for a plurality of nodes to the number of execution batches executed by allocation in the plurality of nodes or executed before predetermined timing.

Thereby, the waiting time until the start of sharing a processing result among the nodes in the case of parallel calculation can be reduced. That is, since the processing of all the nodes is completed at the same time, the wait time to start the Allreduce processing (in other words, the processing of sharing the result among the nodes at the time of parallel calculation) can be reduced.

The number of batches setting unit 112 measures the performance and allocates the number of batches every predetermined number of iterations of learning, or terminates the learning. The number of batches setting unit 112 measures the performance and allocates the number of batches every predetermined time, or terminates the learning. Thereby, even if the temperature of the CPU 11 changes or usage tendency of the computer 1 changes with the passage of time, accurate performance measurement and batch distribution can be performed.

The predetermined timing to terminate the learning is timing when the number of batches executed by the first node of the plurality of nodes has reached a predetermined number since the start of learning. The predetermined timing to terminate the learning is timing when a predetermined time has elapsed since the start of learning. The predetermined timing to terminate the learning is timing when the number of batches executed by all the plurality of nodes has reached a predetermined number since the start of learning. As a result, the wait time of each process can be reduced and the learning can be speeded up.

### [G] Others

The disclosed technology is not limited to the embodiment described above, and various modifications may be made to be implemented without departing from the gist of the present embodiment. Each configuration and each process according to the present embodiment may be selected as needed, or may be combined as appropriate.

In the above-described one example of the embodiment and the first modification, the number of batches is allocated according to the measurement result of the throughput, but it is not limited thereto. For example, clocks of the CPU 11 and the GPU may be monitored, and the number of batches may be distributed according to a clock monitoring result.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a procedure, the procedure comprising:
in learning by a plurality of nodes in deep learning, determining to allocate a number of batches according to a performance of each of the plurality of nodes to the each of the plurality of nodes or to terminate the learning at a predetermined timing; and
adjusting a learning rate to be used for the learning according to a ratio of a preset number of batches for the plurality of nodes to a number of execution batches executed by the allocation in the plurality of nodes or number of execution batches executed before the predetermined timing.

2. The non-transitory computer-readable recording medium storing a program according to claim 1, wherein the procedure includes measuring the performance and the allocation or terminating the learning every predetermined number of iterations of the learning.

3. The non-transitory computer-readable recording medium storing a program according to claim 1, wherein the procedure includes measuring the performance and the allocation or terminating the learning every predetermined time.

4. The non-transitory computer-readable recording medium storing a program according to claim 1, wherein the predetermined timing is a timing when a number of batches executed by a first node of the plurality of nodes has reached a predetermined number since start of the learning.

5. The non-transitory computer-readable recording medium storing a program according to claim 1, wherein the predetermined timing is timing when a predetermined time has elapsed since start of the learning.

6. The non-transitory computer-readable recording medium storing a program according to claim 1, wherein the predetermined timing is timing when a number of batches executed by all the plurality of nodes has reached a predetermined number since start of the learning.

7. A computer including a processor to execute a procedure, the procedure comprising:
in learning by a plurality of nodes in deep learning, determining to allocate a number of batches according to a performance of each of the plurality of nodes to the each of the plurality of nodes or to terminate the learning at a predetermined timing; and
adjusting a learning rate to be used for the learning according to a ratio of a preset number of batches for the plurality of nodes to a number of execution batches executed by the allocation in the plurality of nodes or number of execution batches executed before the predetermined timing.

8. The computer according to claim 7, wherein the procedure includes measuring the performance and the allocation or terminating the learning every predetermined number of iterations of the learning.

9. The computer according to claim 7, wherein the procedure includes measuring the performance and the allocation or terminating the learning every predetermined time.

10. The computer according to claim 7, wherein the predetermined timing is timing when a number of batches executed by a first node of the plurality of nodes has reached a predetermined number since start of the learning.

11. The computer according to claim 7, wherein the predetermined timing is timing when a predetermined time has elapsed since start of the learning.

12. The computer according to claim 7, wherein the predetermined timing is timing when number of batches executed by all the plurality of nodes has reached a predetermined number since start of the learning.

13. A learning method for causing a computer to execute a procedure, the procedure comprising:
in learning by a plurality of nodes in deep learning, determining to allocate a number of batches according to a performance of each of the plurality of nodes to the each of the plurality of nodes or to terminate the learning at a predetermined timing; and
adjusting a learning rate to be used for the learning according to a ratio of a preset number of batches for the plurality of nodes to a number of execution batches executed by the allocation in the plurality of nodes or number of execution batches executed before the predetermined timing.

14. The learning method according to claim 13, for causing the computer to execute processing comprising measuring the performance and the allocation or terminating the learning every predetermined number of iterations of the learning.

15. The learning method according to claim 13, for causing the computer to execute processing comprising measuring the performance and the allocation or terminating the learning every predetermined time.

16. The learning method according to claim 13, wherein the predetermined timing is timing when number of batches executed by a first node of the plurality of nodes has reached a predetermined number since start of the learning.

17. The learning method according to claim 13, wherein the predetermined timing is timing when a predetermined time has elapsed since start of the learning.

18. The learning method according to claim 13, wherein the predetermined timing is timing when a number of batches executed by all the plurality of nodes has reached a predetermined number since start of the learning.
